(19) United States
(12) Patent Application Publication
(10) Pub. No.: US 2012/0295140 A1
(43) Pub. Date: Nov. 22, 2012

(54) EXHAUSTING DEVICE AND ENERGY STORAGE DEVICE INCLUDING THE SAME

(75) Inventors: Yeong Su CHO, Gyeonggi-do (KR); Jun Hee Bae, Seoul (KR); Chang Ryul Jung, Seoul (KR); Bae Kyun Kim, Gyeonggi-do (KR); Hyun Chul Jung, Gyeonggi-do (KR)

(73) Assignee: Samsung Electro-Mechanics Co., Ltd., Suwon (KR)

(21) Appl. No.: 13/455,894

(22) Filed: Apr. 25, 2012

(30) Foreign Application Priority Data
May 17, 2011 (KR) 10-2011-0046456

(51) Int. Cl. H01M 2/12; B01D 46/00; H01G 9/155; F01L 3/10

(52) U.S. Cl. 429/54; 251/337; 137/544; 55/385.4; 361/502

(57) ABSTRACT

There is provided an exhausting device and an energy storage device, including: a housing; a lower valve; an upper valve; a cover; and an elastic member provided between a lower surface of the cover and an upper surface of the opening/closing member to provide a downward pressure to the opening/closing member, and it can appropriately release an increase in an inside pressure due to gas generated inside an energy storage device by the exhausting device, thereby improving reliability of the energy storage device, extending lifespan of the energy storage device, and allowing semi-permanent use of the energy storage device.

### CROSS REFERENCE(S) TO RELATED APPLICATIONS

This application claims the benefit under 35 U.S.C. Section 119 of Korean Patent Application Serial No. 10-2011-0046456, entitled “Exhausting Device and Energy Storage Device Including the Same” filed on May 17, 2011, which is hereby incorporated by reference in its entirety into this application.

### BACKGROUND OF THE INVENTION

1. Technical Field

The present invention relates to an exhausting device and an energy storage device including the same.

2. Description of the Related Art

Recently, various kinds of mobile electronic products are launching, boosted by technical development of electrical and electronic communications, and energy storage devices such as secondary batteries are being utilized in wide fields.

In addition, as an interest in environmental problems and resource problems increase, competition for development of techniques related to generation of environment-friendly energy such as vehicles utilizing environment-friendly energy or solar power generation is intense.

A typical electric energy storage device widely used until now is a secondary battery capable of being long used through charging and discharging. The secondary battery is previously used as a power storage device of small mobile equipments since an output thereof is maintained in a constant voltage for a relatively long time and miniaturization and lightness thereof are possible.

Meanwhile, the secondary battery has a limitation in application thereof, because there are problems in that it takes a relatively long time for charging and discharging, a relatively low output of around 3V, a short lifespan, and a risk of explosion.

Therefore, as an energy storage device capable of supplementing these disadvantages, there is an increasing interest in super capacitors, which perform charging and discharging operations by electrochemical mechanism.

There are various kinds of super capacitors such as an electric double layer capacitor (EDLC), a hybrid capacitor, a pseudo capacitor, and the like, which have advantages in that instant charging is possible, output characteristics are superiorly high, and also lifespan is superiorly long.

Based on the above advantages, a study on uses of the super capacitors, in respect to regenerative braking of vehicles or the like, is continuing.

Meanwhile, in the energy storage devices, such as secondary batteries and super capacitors, an electrolytic solution (or electrolyte) is provided between electrodes, and charging and discharging procedures progress by electrochemical mechanism. In this case, various kinds of gases may be generated. If the gas is not properly exhausted, a case of the energy storage device is disrupted, and thus it cannot be further used, or it may have a risk of explosion in serious cases.

Although the super capacitors are not smoothly commercialized because problems with respect to energy density and resistance have not been solved until now, it is expected that commercialization thereof is possible soon.

However, the need for solving the problems such as degradation in reliability and decrease of lifespan due to generation of the above gas is emerging.

Meanwhile, FIG. 1 exemplifies a structure of an air valve according to Korean Patent Application No. 2003-47556, which is proposed in order to exhaust an inside gas of an energy storage device.

Referring to FIG. 1, in a case of an air valve described in the patent document, when a gas is generated inside an energy storage device to lead an increase in pressure, a thin metal film 1 ruptures to exhaust the gas. In the case of employing this type, there is a problem in that the metal film 1 needs to be replaced with a new one whenever the metal film 1 ruptures.

### SUMMARY OF THE INVENTION

An object of the present invention is to provide an exhausting device capable of maintaining an inside pressure of an energy storage device in a predetermined range and being semi-permanently used, and an energy storage device including the same.

According to an exemplary embodiment of the present invention, there is provided an exhausting device, including: a housing having an opened upper portion and a lower surface having penetration holes; a lower valve inserted inside the housing, and shaped in a figuration of which an upper portion is narrow and a lower portion is wide; an upper valve shaped in a figuration of which an upper portion is wide and a lower portion is wide, symmetrically to the lower valve, and including a lower surface coupled to an upper surface of the lower valve, a lateral surface having vent holes, and an upper surface partially or entirely opened to allow fluid to be moved from the vent holes to the opened part; an opening/closing member having a lateral surface contacted with an inner wall of the housing and an opening/closing hole provided in the center thereof, the lower valve and the upper valve being inserted into the opening/closing hole; a cover contacted with the upper surface of the upper valve and coupled with the housing, and having an exhausting hole; and an elastic member provided between a lower surface of the cover and an upper surface of the opening/closing member to provide a downward pressure to the opening/closing member.

The lower valve may be shaped in one figuration selected from a truncated circular cone, a truncated oval cone, and a truncated polygonal cone.

The exhausting device may further include a filtering member provided on the upper surface of the upper valve.

The exhausting device may further include a filtering member provided in the exhausting hole of the cover.

The filtering member may be made of stainless or aluminum-based metal materials.

The filtering member may be formed in a net body of 400 mesh or less.

According to another exemplary embodiment of the present invention, there is provided an energy storage device, including: the exhausting device as described above; a cover having an anode terminal, a cathode terminal, and a hole, a lower surface of the cover being coupled with the cover of the exhausting device; and a case containing an energy storage body therein, and air-tightly coupled with the cover.

The lower surface of the exhausting device may also be coupled with an upper surface of the cover.

### BRIEF DESCRIPTION OF THE DRAWINGS

FIG. 1 is a cross-sectional view of an air valve for exhausting gas in an energy storage device according to the related art;

FIG. 2 is a schematic perspective view of an exhausting device according to an exemplary embodiment of the present invention;

FIG. 3A is an exploded perspective view of the exhausting device according to the exemplary embodiment of the present invention;

FIG. 3B is a perspective view illustrating a state where an upper valve and a lower valve are coupled with each other in the exhausting device according to the exemplary embodiment of the present invention;

FIGS. 4A and 4B are schematic cross-sectional views illustrating an operating principle of the exhausting device according to the exemplary embodiment of the present invention;

FIG. 5 is an exploded perspective view of an energy storage device according to an exemplary embodiment of the present invention; and

FIG. 6 is an exploded perspective view of an energy storage device according to another exemplary embodiment of the present invention.

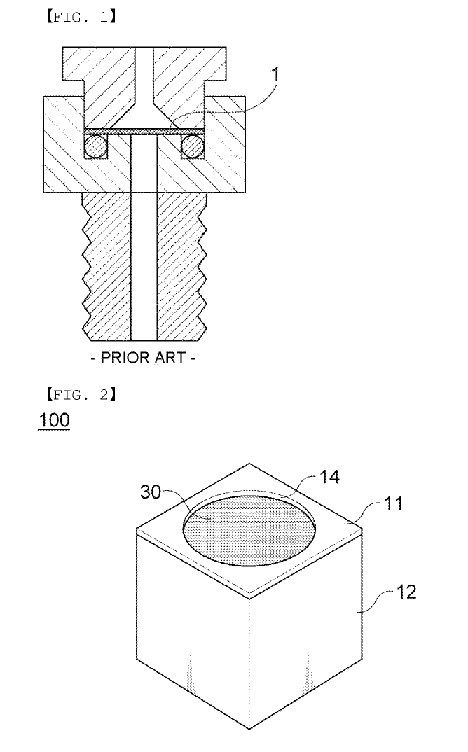

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, constitution and operation of the present invention will be described in more detail with reference to the accompanying drawings.

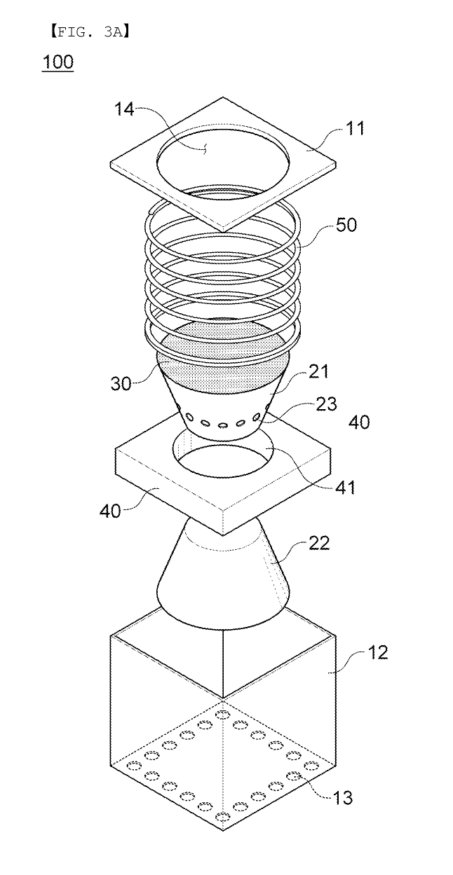

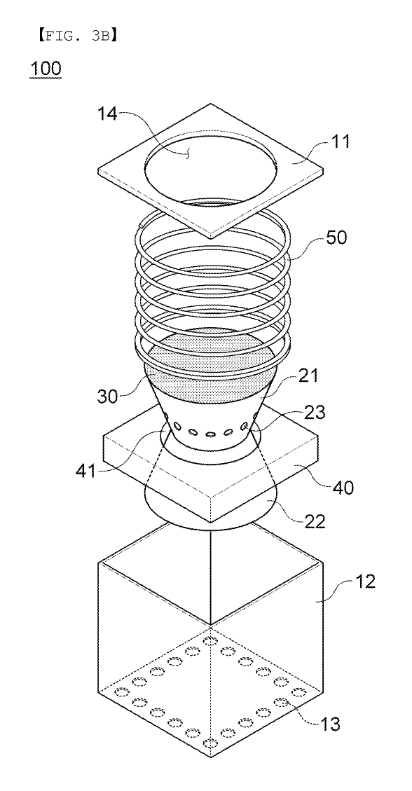

FIG. 2 is a schematic perspective view of an exhausting device 100 according to an exemplary embodiment of the present invention; FIG. 3A is an exploded perspective view of the exhausting device 100 according to the present invention; and FIG. 3B is a perspective view illustrating a state where an upper valve 21 and a lower valve 22 are coupled with each other in the exhausting device 100 according to the exemplary embodiment of the present invention.

Referring to FIGS. 2 to 3B, the exhausting device 100 according to the exemplary embodiment of the present invention can include a housing 12, a lower valve 22, an upper valve 21, an opening/closing member 40, a cover 11, and an elastic member 50.

The housing 12 may be shaped in a hexagonal column of which an upper surface is opened.

Here, a plurality of penetration holes 13 may be provided in a lower surface of the housing 12.

Since the lower valve 22 may be shaped in a figuration of which an upper portion is narrow and a lower portion is wide, and the upper valve 21 may be shaped in a figuration of which an upper portion is wide and a lower portion is narrow, and thus, the lower valve 22 and the upper valve 21 can be coupled with each other.

Here, the lower valve 22 may be shaped in a truncated circular cone, a truncated oval cone, a truncated polygonal cone, or the like, and the upper valve 21 may be symmetrically formed according to the shape of the lower valve 22.

Meanwhile, an inside of the upper valve 21 may be vacant.

Here, an upper surface of the upper valve 21 may be partially or entirely opened.

In addition, one or more vent holes 23 may be formed in a lateral surface of the upper valve 21.

Therefore, fluid outside the upper valve 21 can be moved inside the upper valve 21 through the vent holes 23, and exhausted through an opening part provided in the upper surface of the upper valve 21.

The opening/closing member 40 has a lateral surface contacted with an inner wall of the housing 12. Here, preferably, the lateral surface of the opening/closing member 40 is air-tightly contacted with the inner wall of the housing 12.

An opening/closing hole 41 is provided in the center of the upper surface of the opening/closing member 40 such that it penetrates an upper portion and a lower portion of the opening/closing member 40. A part including a coupling face between the upper valve 21 and the lower valve 22 may be inserted inside the opening/closing hole 41.

Here, the opening/closing member 40 may be moved in a vertical direction between the lower surface of the lower valve 22 and the upper surface of the upper valve 21.

The cover 11 may be coupled with the housing 12 above the upper valve 21, and may fix the upper valve 21 and the lower valve 22 inside the housing 12.

In addition, an exhausting hole 14 is provided in the center of the cover 11 to allow the fluid passing through the upper valve 21 to be exhausted to the outside.

The elastic member 50 may be provided between a lower surface of the cover 11 and an upper surface of the opening/closing member 40 to provide a downward pressure to the opening/closing member 40.

A case where the elastic member 50 is embodied as spring is exemplified in the drawings, but the elastic member 50 is not limited thereto.

Here, FIGS. 3A and 3B show a case where the opening/closing member 40 is positioned between the upper valve 21 and the lower valve 22, and the upper valve 21 and the lower valve 22 are coupled with each other while a lower portion of the upper valve 21 and an upper portion of the lower valve 22 are inserted into the opening/closing hole 41. However, preferred embodiments of the present invention are not limited to this constitution.

That is to say, even when the opening/closing member 40 consists of two or more pieces and the upper valve 21 and the lower valve 22 are formed in one body, central parts of the upper valve 21 and the lower valve 22, which is a concaved region, can be inserted into the opening/closing hole 41 of the opening/closing member 40.

Meanwhile, a filtering member 30 may be provided in the exhausting hole 14 or on an opening part of the upper surface of the upper valve 21.

The filtering member 30 functions to prevent external materials from being put into the exhausting device 100 to cause mal-operation of the exhausting device 100.

Here, the filtering member 30 may be made of stainless or aluminum-based metal materials having superior corrosion-resistance, and preferably formed in a net body of 400 mesh or less in order to prevent infiltration of external materials and maximize efficiency in exhaustion of gas.

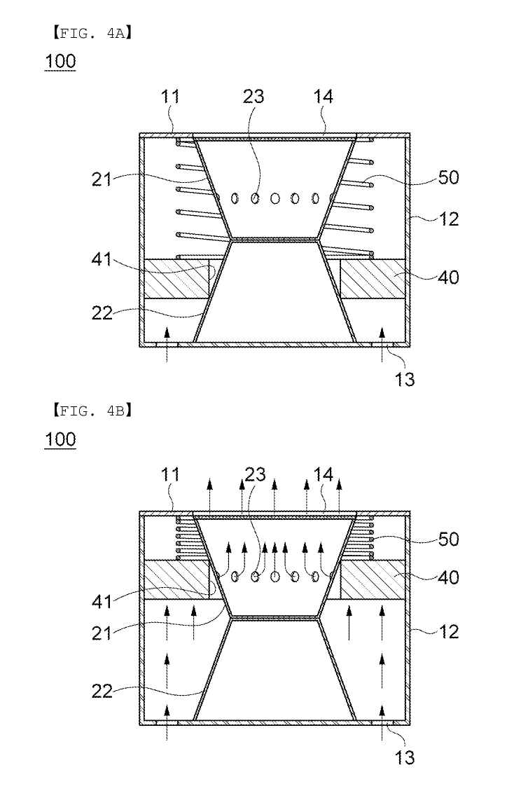

FIGS. 4A and 4B are schematic cross-sectional views illustrating an operating principle of an exhausting device 100 according to an exemplary embodiment of the present invention. FIG. 4A shows a state where gas is not exhausted since a pressure of gas generated inside the energy storage device is lower than a pressure downwardly provided by the elastic member 50; and FIG. 4B shows a state where gas is exhausted since a pressure of gas generated inside the energy storage device is higher than a pressure downwardly provided by the elastic member 50.

Referring to FIG. 4A, when a pressure of gas inflowing through the penetration holes 13 of the housing 12 is low, the opening/closing member 40 is downwardly pressed by the elastic member 50, and thus an inner lateral surface of the opening/closing hole 41 can be air-tightly contacted with an outer lateral surface of the lower valve 22.

Accordingly, the gas inflowing through the penetration holes 13 of the housing 12 does not flow out.

Referring to FIG. 4B, when a pressure of gas inflowing through the penetration holes 13 of the housing 12 is higher than elastic force of the elastic member 50, the opening/closing member 40 is upwardly moved to separate the opening/closing hole 41 and the lower valve 22 from each other, and thus, the gas can be upwardly moved.

This moved gas flows into the penetration holes 13 provided in the lateral surface of the upper valve 21, and then passes through the opening part provided in the upper surface of the upper valve 21, the filtering member 30, and the exhausting hole 14 of the cover 11, and thus, can be exhausted to the outside.

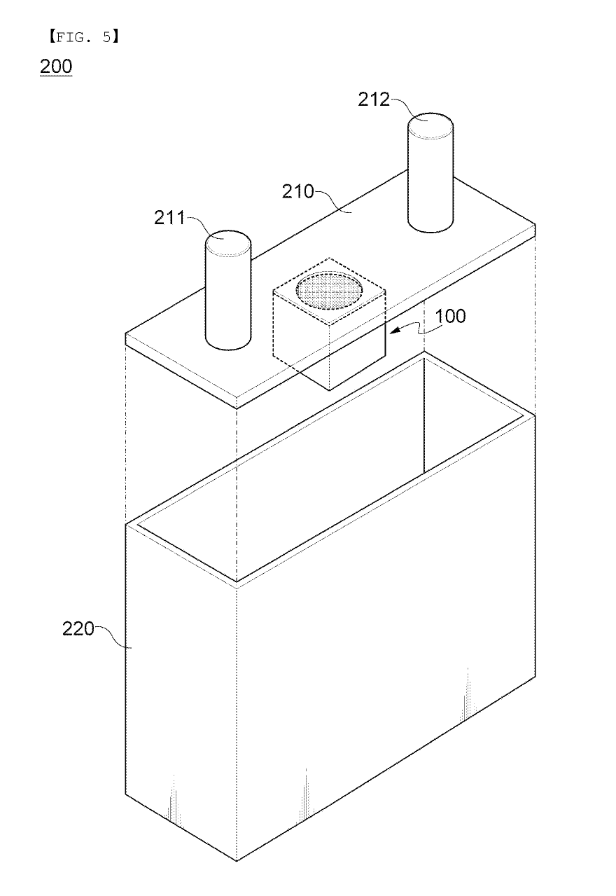

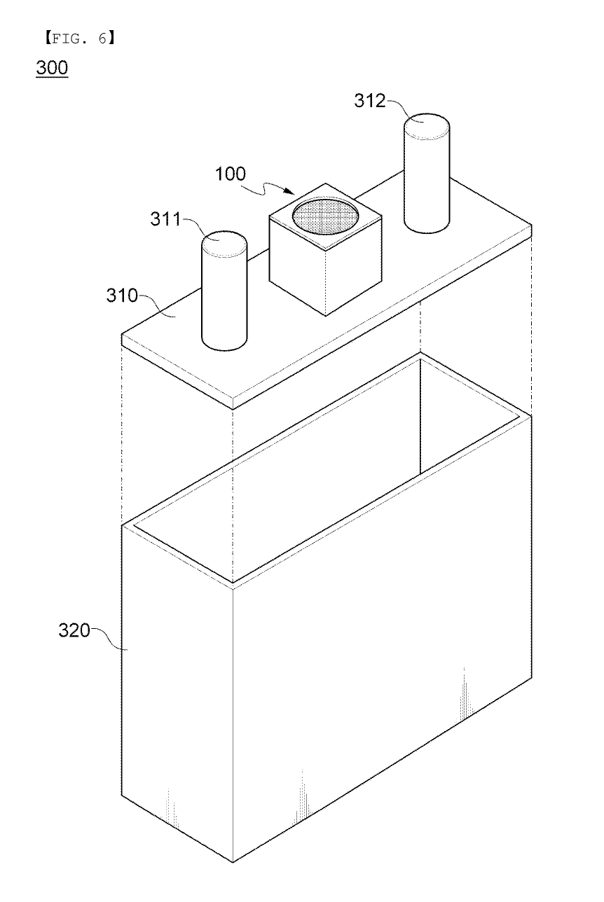

FIG. 5 is an exploded perspective view of an energy storage device according to an exemplary embodiment of the present invention; and FIG. 6 is an exploded perspective view of an energy storage device according to another exemplary embodiment of the present invention.

Referring to FIGS. 5 and 6, the energy storage devices 200 and 300 according to the exemplary embodiments of the present invention may include covers 210 and 310, energy storage bodies (not shown), and cases 220 and 320.

The covers 210 and 310 may include anode terminals 211 and 311 and cathode terminals 212 and 312 in the necessary number, and the above-described exhausting device 100 may be coupled to upper surfaces or lower surfaces of the covers 210 and 310, respectively.

Here, holes may be provided in the cover correspondingly to the penetration holes 13 provided in the lower surface of the exhausting device 100 or the exhausting hole 14 provided in the upper surface of the exhausting device 100.

Accordingly, when an inside pressure is higher than a predetermined critical value due to gas generated inside the energy storage devices 200 and 300, the gas can be exhausted to the outside passing through the exhausting device 100.

As set forth above, the present invention appropriately release an increase in an inside pressure due to gas generated inside an energy storage device, thereby improving reliability of the energy storage device, extending lifespan of the energy storage device, and allowing semi-permanent use of the energy storage device.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An exhausting device, comprising:
a housing having an opened upper portion and a lower surface having penetration holes;
a lower valve inserted inside the housing, and shaped in a figuration of which an upper portion is narrow and a lower portion is wide;
an upper valve shaped in a figuration of which an upper portion is wide and a lower portion is wide, symmetrically to the lower valve, and including a lower surface coupled to an upper surface of the lower valve, a lateral surface having vent holes, and an upper surface partially or entirely opened to allow fluid to be moved from the vent holes to the opened part;
an opening/closing member having a lateral surface contacted with an inner wall of the housing and an opening/closing hole provided in the center thereof, the lower valve and the upper valve being inserted into the opening/closing hole;
a cover contacted with the upper surface of the upper valve and coupled with the housing, and having an exhausting hole; and
an elastic member provided between a lower surface of the cover and an upper surface of the opening/closing member to provide a downward pressure to the opening/closing member.

2. The exhausting device according to claim 1, wherein the lower valve is shaped in one figuration selected from a truncated circular cone, a truncated oval cone, and a truncated polygonal cone.

3. The exhausting device according to claim 1, further comprising a filtering member provided on the upper surface of the upper valve.

4. The exhausting device according to claim 1, further comprising a filtering member provided in the exhausting hole of the cover.

5. The exhausting device according to claim 3, wherein the filtering member is made of stainless or aluminum-based metal materials.

6. The exhausting device according to claim 3, wherein the filtering member is formed in a net body of 400 mesh or less.

7. An energy storage device, comprising:
the exhausting device according to claim 1;
a cover having an anode terminal, a cathode terminal, and a hole, a lower surface of the cover being coupled with the cover of the exhausting device; and
a case containing an energy storage body therein, and air-tightly coupled with the cover.

8. An energy storage device, comprising:
the exhausting device according to claim 1;
a cover having an anode terminal, a cathode terminal, and a hole, an upper surface of the cover being coupled with the lower surface of the exhausting device; and
a case containing an energy storage body therein, and air-tightly coupled with the cover.

9. The exhausting device according to claim 4, wherein the filtering member is made of stainless or aluminum-based metal materials.

10. The exhausting device according to claim 4, wherein the filtering member is formed in a net body of 400 mesh or less.
